(19) United States
(12) Patent Application Publication
(10) Pub. No.: US 2012/0194328 A1
(43) Pub. Date: Aug. 2, 2012

(54) VEHICLE APPROACH WARNING APPARATUS

(75) Inventors: Toshiaki NAKAYAMA, Miyoshi-city (JP); Kouji Sakurai, Chita-gun (JP); Koji Suzuki, Kosai-city (JP); Yoshiaki Watanabe, Kosai-city (JP)

(73) Assignees: HAMANAKODENSO CO., LTD., Kosai-city (JP); DENSO CORPORATION, Kariya-city (JP)

(21) Appl. No.: 13/354,724

(22) Filed: Jan. 20, 2012

(30) Foreign Application Priority Data
Jan. 27, 2011 (JP) 2011-15516

(51) Int. Cl. B60Q 1/00

(52) U.S. Cl. 340/425.5

(57) ABSTRACT

A vehicle warning apparatus has a vehicular horn disposed in an overlapping arrangement with a supersonic speaker, such that the vehicular horn is positioned between the supersonic speaker and a heat exchanger. The vehicular horn blocks the supersonic speaker from heat produced by the heat exchanger, which prevents the temperature of the supersonic speaker from increasing. Accordingly, troubles such as frequency change of supersonic wave output from the speaker and/or decrease of speaker's product life, without deteriorating heat dissipation capacity of the heat exchanger, are prevented. Furthermore, collective arrangement of the supersonic speakers on a single board attached on the vehicular horn improves the install-ability of the vehicle warning apparatus in the vehicle, and improves the directional reach of the supersonic wave.

### CROSS REFERENCE TO RELATED APPLICATION

The present application is based on and claims the benefit of priority of Japanese Patent Application No. 2011-15516, filed on Jan. 27, 2011, the disclosure of which is incorporated herein by reference.

### TECHNICAL FIELD

The present disclosure generally relates to a vehicle warning apparatus that generates a notification sound for warning a pedestrian and the like around the vehicle about the approach of the vehicle.

### BACKGROUND

A warning device that outputs a sound to notify others in the vicinity of the traveling vehicle is disclosed in Japanese Patent Laid-Open No. 2005-289175 (JP '175). The vehicle warning apparatus of JP '175 generates the sound from a dynamic speaker.

A vehicle warning apparatus may also use a different type of speaker that provides a strong directivity to generate the sound.

In order to effectively have such a speaker transmit the sound that radiates outward from the vehicle in a frontal direction of the vehicle, the speaker may be affixed to a front portion of the vehicle. For example, a vehicle with a vehicular horn, which generates a sound according to an operation of a horn switch by an occupant of the vehicle, is generally disposed at a position between the heat exchanger and the front grille, as provided in Japanese Patent Laid-Open No. 2009-006899 (JP '899).

However, such position may not be appropriate for the speaker due to the operation of certain vehicle components that may have an adverse affect on the quality of the sound transmitted and, even, the product life of the speaker. Therefore, the speaker may have to be disposed in a different location, which may not be feasible due to the spatial restrictions that are associated with the frontal portions of a vehicle, and the added manufacturing cost for installing such speaker.

### SUMMARY

In view of the above and other problems, the present disclosure provides a vehicle warning apparatus that prevents heat from a heat exchanger from affecting a supersonic speaker, without deteriorating the heat dissipation capacity of the heat exchanger due to the arrangement of the supersonic speaker in front of the heat exchanger.

A vehicle warning apparatus is equipped in a vehicle, where the vehicle includes a heat exchanger that is positioned at a front position of the vehicle to be cooled by a travel-caused wind and a vehicular horn that generates a warning sound when a horn switch is operated by a vehicle occupant. The vehicle warning apparatus includes a parametric speaker that outputs a supersonic wave outwards from the vehicle with the use of a supersonic speaker. The supersonic speaker is arranged with the vehicular horn in an overlapping manner, such that the vehicular horn is disposed between the heat exchanger and the supersonic speaker.

Due to such arrangement, heat from the heat exchanger does not directly hit or come into contact with the supersonic speaker. As a result, the temperature of the supersonic speakers is controlled, and the quality of the supersonic wave generated by the supersonic speaker and the product life of the supersonic speaker are not adversely affected by the heater exchanger.

Furthermore, the passage of air into the heat exchanger is not obstructed. Therefore, the heater dissipation capacity of the heat exchanger is not adversely affected by the vehicle warning apparatus.

The vehicular horn may be equipped with a swirl shape horn that intensifies the warning sound produced by the vehicular horn, where the swirl shape horn may have a curved contour that defines an opening at one end from which the warning sound is emitted. The supersonic speaker is arranged on an outer surface of the curved body of the swirl shape horn, such that the supersonic speaker is positioned next to the swirl shape horn and in front of the vehicular horn. In other words the supersonic speaker can be considered integrated with the vehicular horn. Therefore, the supersonic speaker can be installed in the vehicle together with the vehicular horn.

Further, the supersonic speaker may include a support board and a plurality of speakers. The support board may be configured to have a flat planar shape on which the speakers are arranged. In such manner, the supersonic waves output from the multiple supersonic vibrators have a synchronized wave phase with each other, thereby improving the intensity of the supersonic wave output from the speakers and increasing the purview or reach of the supersonic wave.

Further, the supersonic speaker may also be integrated within an outer contour of the vehicular horn. In such manner, the supersonic speaker does not obstruct the flow of air into the heat exchanger. Therefore, the heat dissipation capacity of the heat exchanger is not adversely affected by the supersonic speaker.

### BRIEF DESCRIPTION OF THE DRAWINGS

Objects, features, and advantages of the present disclosure will become more apparent from the following detailed description made with reference to the accompanying drawings, in which:

FIG. 1 is an illustration of a vehicle warning apparatus of the present disclosure;

FIG. 2A is a cross-sectional view of the vehicle warning apparatus of the present disclosure;

FIG. 2B is a perspective view of the vehicle warning apparatus of FIG. 2A of the present disclosure;

FIG. 3 is a diagram of a frequency characteristic of a vehicular horn of the vehicle warning apparatus of the present disclosure;

FIGS. 4A and 4B are illustrations of outreach areas of a notification sound of the present disclosure;

FIG. 5 is a block diagram of the vehicle warning apparatus of the present disclosure;

FIGS. 6A, 6B, 6C, 6D to 6E are illustrations of an operation principle of a parametric speaker of the vehicle warning apparatus of the present disclosure;

FIGS. 7A and 7B are illustrations of relative positions of a piezoelectric speakers and a grille member of the vehicle warning apparatus of the present disclosure; and

FIG. 8 is an illustration of an arrangement of the piezoelectric speakers of the vehicle warning apparatus of the present disclosure.

### DETAILED DESCRIPTION

With reference to the drawings, embodiments of the present disclosure are explained. In the following examples, like parts have like numbers. It is to be noted that the following examples do not limit the present disclosure to only themselves.

### First Embodiment

A vehicle 100 in the present embodiment may generate driving power by using an electric motor and/or an internal combustion engine, such as an electric vehicle, a hybrid vehicle, or the like. As a result the vehicle 100, may be considered a quiet vehicle that generates little to no sound when the vehicle 100 is in operation.

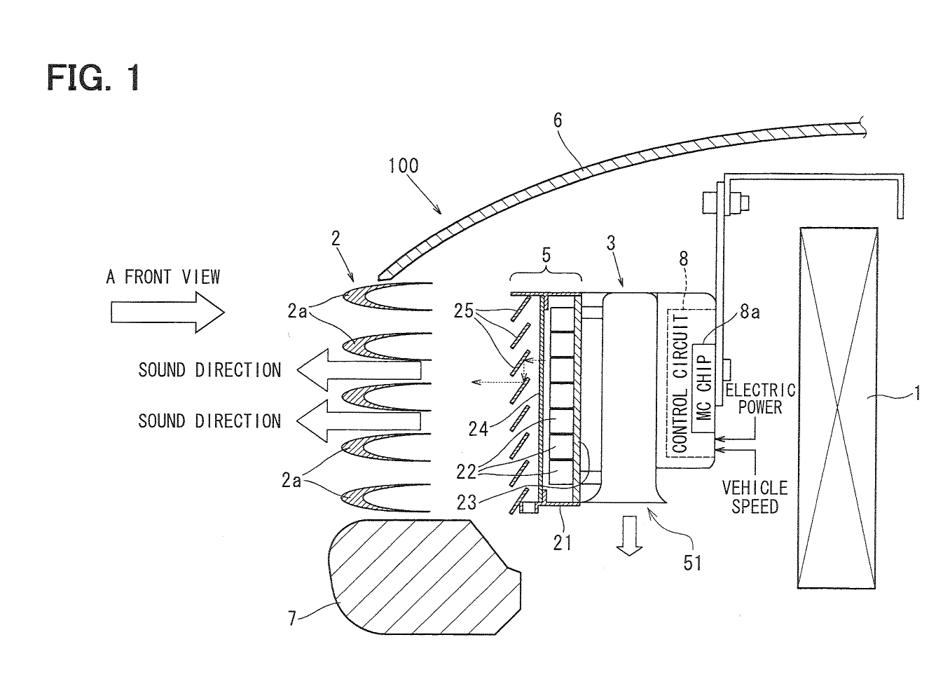

With reference to FIG. 1, the vehicle 100 includes a heat exchanger 1, a front grille 2, an engine hood 6, and a bumper 7. The heat exchanger 1, as known in the art, may be a radiator that transfers heat created during the operation of the vehicle 100 to the air passing through the heat exchanger 1. The heat exchanger may also have a condenser that transfers heat from refrigerant.

The front grille 2 of the vehicle 100 covers a front opening of the vehicle 100 to protect the internal components such as, the heat exchanger 1, an engine, a motor, and the like. The front grille 2 in the present embodiment is molded by resin and has grille members 2a that may have a lattice-shape. During the travel of the vehicle 100, air or travel-producing wind travels between the grille members 2a to the heat exchanger 1 to absorb the heat from the heat exchanger 1.

The vehicle 100 of the present embodiment also includes a vehicular horn 3, which may be an electro-magnetic type horn. The vehicular horn 3 emits a warning sound when a horn switch (e.g., a horn button on a steering wheel) is operated by an occupant of the vehicle 100. That is when the horn switch is engaged, the vehicular horn 3 generates the warning sound when a self-excitation voltage is above a threshold voltage, such as 8 V or more. The vehicular horn is disposed in a front portion of the vehicle 100 between the heat exchanger 1 and the front grille 2.

In addition, the vehicular horn 3 in the present embodiment may also serve as a dynamic speaker, for also outputting a notification sound from a vehicle warning apparatus, which is described further below.

The vehicle 100 includes the vehicle warning apparatus to notify the surrounding area of the presence and approach of the vehicle 100. The vehicle warning apparatus includes a parametric speaker 4 that outputs a supersonic wave via a supersonic speaker 5, the vehicular horn 3 that is operated as a dynamic speaker, and a control circuit 8 that controls the operation of the vehicular horn 3 and the supersonic speaker 5. The notification sound may be produced based on a travel condition of the vehicle 100 or when a pedestrian is detected by a sensor or the like.

The vehicle warning apparatus is configured to output the notification sound from both the parametric speaker 4, which uses a supersonic wave, and the vehicular horn 3, which serves as a dynamic speaker, toward the surrounding area of the vehicle 100.

(Vehicular Horn 3)

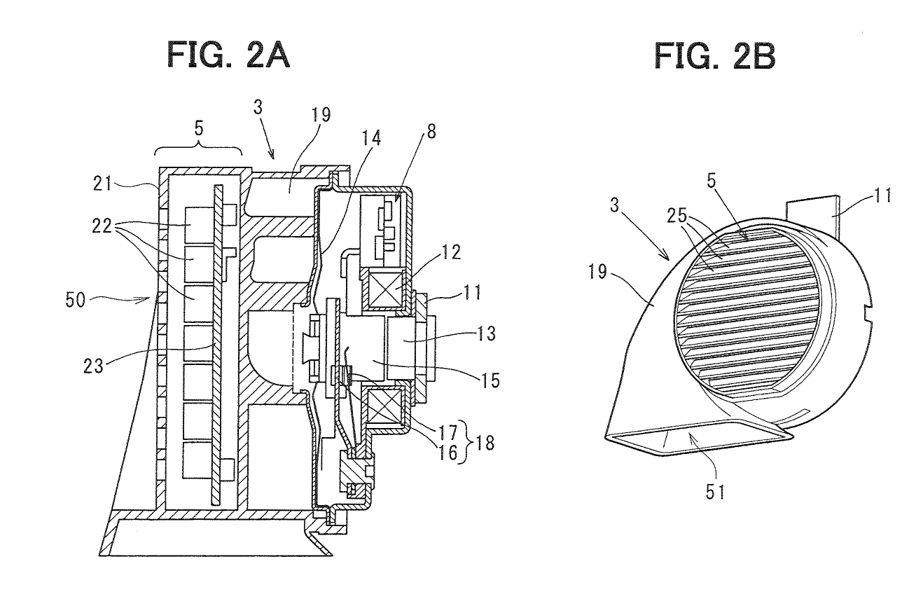

With reference now to FIGS. 2A and 2B, the vehicular horn 3 is affixed with a stay 11, and includes a coil 12 to generate a magnetic force, a fixed iron core 13, a movable iron core 15, and a movable contact point 17. The fixed iron core 13 outputs an attraction force that is generated as a magnetic force from the coil 12, and may be referred to as a magnetic attraction core.

The movable iron core 15 is supported at the center of a vibration board 14 or a diaphragm. The attraction force provided by the fixed core 13, moves the movable iron core 15 towards the fixed iron core 13, and, as a result, the movable contact point 17 decouples from a fixed contact point 16, which interrupts the electric current supplied to the coil 12.

In particular, the self-excitation voltage is supplied across the coil 12 via power terminals that are coupled to the ends of the coil 12, and a current flows across the coil 12. When the self-excitation voltage is above a threshold (i.e., the voltage is equal to or greater than 8 V), an attracting action and a returning action is repeatedly performed within the vehicular horn 3.

Specifically, in regards to the attracting action, when the current flows through the coil 12, an electromagnetic field is generated and an attraction occurs between the movable iron core 15 and the fixed iron core 13, such that the movable iron core 15 moves towards the fixed iron core 13. Due to the movement of the movable iron core 15 towards the fixed iron core 13, the moveable contact point 17 decouples from the fixed contact point 16, causing the current to stop flowing through the coil 12.

Once, the current has stopped flowing through the coil 12, the electromagnetic field is no longer generated and the moveable iron core 15 returns to its initial position, which is the returning action. Due to the biasing of the movable iron core 15, the movable contact point 17 couples with the fixed contact point 16, and the current resumes flowing through the coil 12, thus restarting the attracting action.

In other words, when the self-excitation voltage is equal to or greater than the threshold voltage the current flows through the coil 12, and an electric current interrupter 18, which allows and prevents the current from flowing through the coil 12, is formed by the fixed contact point 16 and the movable contact point 17.

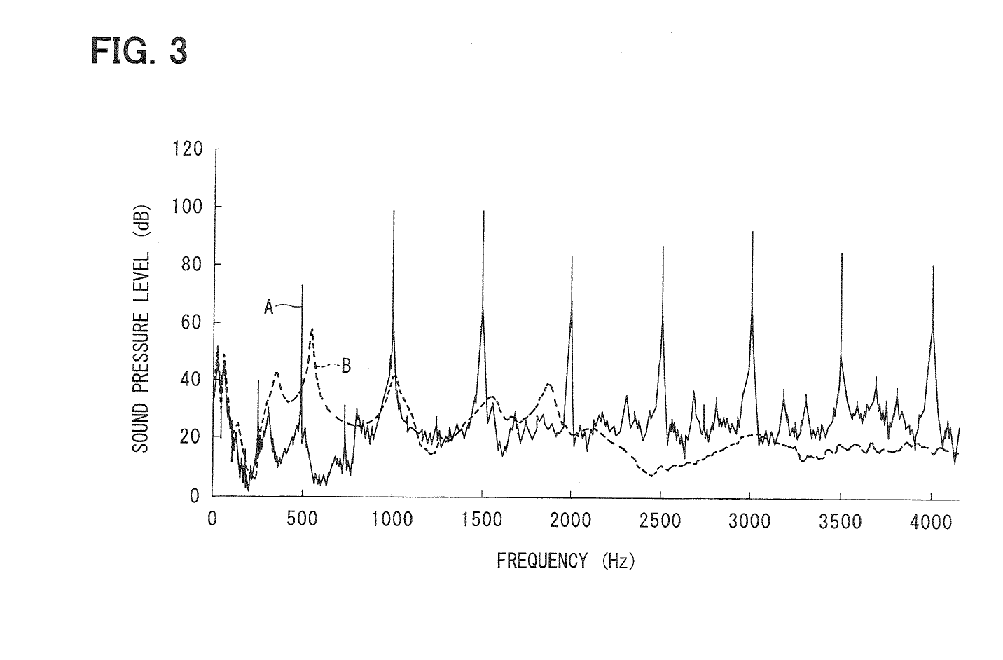

Due to the attracting and returning action, the movable iron core 15 causes a vibration of the vibration board 14, and the vehicular horn 3 generates the warning sound. The vehicular horn 3 generates the warning sound having predetermined frequencies (for example, 500 Hz and the like), one of which serves as a base sound. The frequency characteristics of the warning sound generated when the self-excitation voltage is greater than or equal to 8V by the vehicular horn 3 is shown by a solid line A in FIG. 3.

Further, in the present embodiment, the vehicular horn 3 is operated as a dynamic speaker by providing a driving signal of an excitation voltage that is lower than the threshold voltage for the vehicular horn 3, such as an excitation voltage lower than 8 V.

The frequency characteristics of the vehicular horn 3 at a time of using the vehicular horn 3 as a dynamic speaker are shown by a dashed line B in FIG. 3. The dashed line B shows the frequency characteristics when a sweep signal (i.e., a variable signal transiting from a low frequency to a high frequency) of 1 V in a sine wave form is provided for the vehicular horn 3.

The vehicular horn 3 in the present embodiment includes a swirl shape horn 19 that has a slightly curved body or curved contour that defines a horn opening 51 (i.e., a trumpet member in a swirling shape: a sound tube in a swirl shape) as shown in FIG. 2B. The swirl shape horn 19 amplifies the sound generated by the vibration of the vibration board 14, and radiates the amplified sound outward from the vehicle 100 to the surrounding area via the horn opening 51.

(Supersonic Speaker 5)

The supersonic speaker 5 is a supersonic wave generator generating air vibration having a frequency that is higher than the human audible range (i.e., greater than 20 kHz). The supersonic speaker 5 is disposed between the heat exchanger 1 and the front grille 2 to emit a supersonic wave that radiates outward from the vehicle 100.

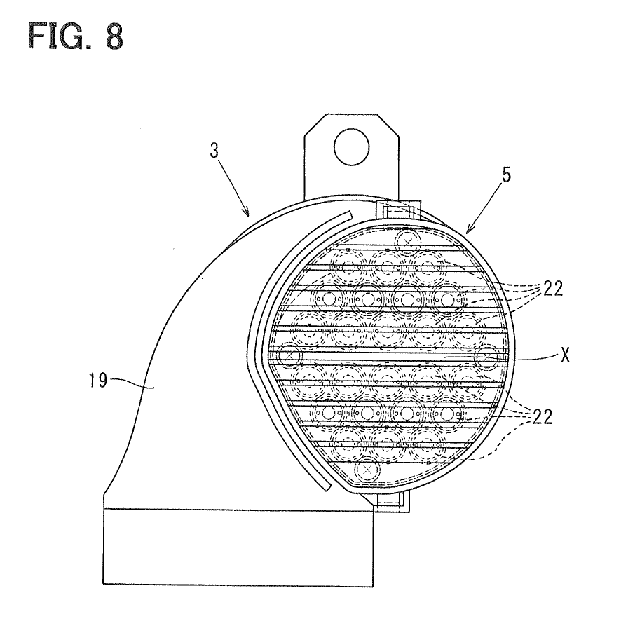

The vehicular horn 3 is disposed between the supersonic speaker 5 and the heat exchanger 1 in an overlapping manner. Specifically, when the vehicle 100 is viewed from a front view, which is provided as a direction viewed towards the front grille 2, the bumper 7, and/or the heat exchanger 1 (see FIG. 1), the supersonic speaker 5 appears to substantially superimpose or is in-front of the vehicular horn 3. The position of the supersonic speaker 5, when viewed from a front view, may further be described as being part of or contained in an outline silhouette or contour of the vehicular horn 3 (as shown in FIG. 1, 2A, 2B and FIG. 8, as an example).

The supersonic speaker 5 can be attached to the swirl shape horn 19 of the vehicular horn 3. Specifically, the supersonic speaker may be affixed to a side plane of the swirl shape horn, as shown in FIG. 2B. In such manner, the supersonic wave from the supersonic speaker 5 is emitted outward from the vehicle 100 toward the grille 2 and/or a frontal direction of the vehicle 100.

The supersonic speaker 5 in the present embodiment includes a supersonic speaker housing 21 that can be made of resin. The supersonic speaker housing 21 may be integrally formed with the swirl shape horn 19 or may be attached to the swirl shape horn 19.

A plurality of piezoelectric speakers 22 are accommodated in the supersonic speaker housing 21. Each of the piezoelectric speakers 22 is disposed on a support board 23 of the supersonic speaker housing 21, to be implemented as a speaker array.

More practically, the support board 23 is a flat disk shape member, and multiple piezoelectric speakers 22 are collectively arranged on the same plane of the support board 23.

Further, the piezoelectric speakers 22 have a well-known structure including the piezoelectric elements that expand and contract according to the applied voltage (i.e., the voltage from charge and discharge), and the vibration board produces air vibration by the expansion and contraction of the piezoelectric elements.

The supersonic speaker housing 21 defines a speaker opening 50 from which a supersonic wave generated by the piezoelectric speakers 22 is outputted. The speaker opening 50 includes a waterproof device that prevents an intrusion of water into the piezoelectric speakers 22.

For example, in the present embodiment the waterproof device is provided as a waterproof sheet 24 that covers the speaker opening 50 and has a supersonic wave transmitting characteristics. The waterproof device also includes a louver 25 that is positioned in front of the waterproof sheet 24 (see FIG. 1).

The louver 25 is arranged in front of the waterproof sheet 24 in order to substantial reduce the amount of water that may reach the waterproof sheet 24, and prevent water from directly hitting the waterproof sheet 24. The louver 25 is formed as multiple narrow boards that are disposed in parallel with gaps interposed therebetween.

The louver 25 can be disposed at an angle of 45 degrees against the vehicle 100's level (i.e., horizontal) direction. In such manner, the supersonic wave outputted from each of the piezoelectric speakers 22 is reflected into a downward direction on an inside of the louver 25, and is then reflected again into a horizontal direction on an outside of the louver 25 toward the front of the vehicle 100, to be output in the travel direction of the vehicle 100 (see FIG. 1).

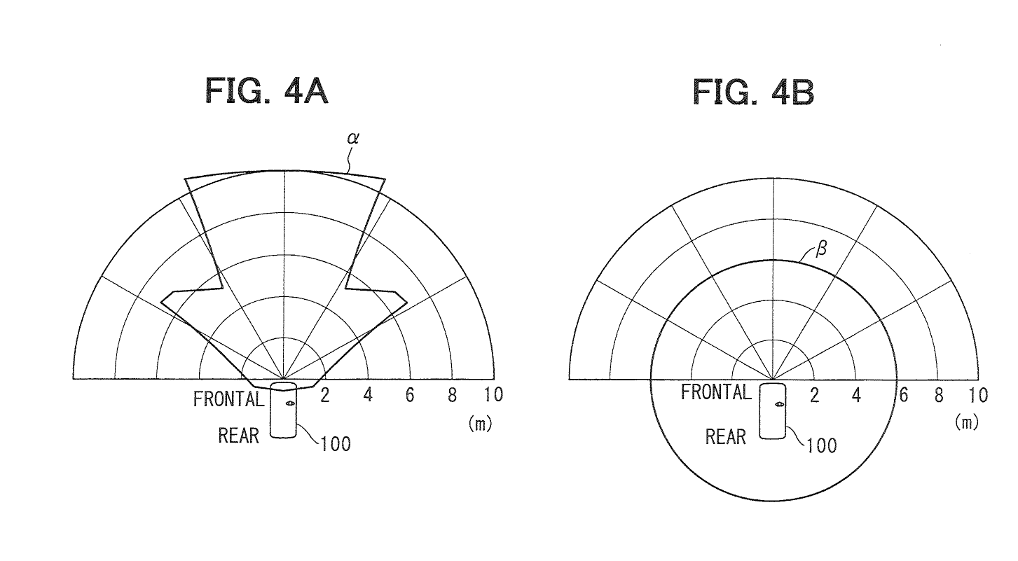

FIG. 4A illustrates a coverage area a of the notification sound from the parametric speaker 4 and FIG. 4B illustrates a coverage area β of the notification sound from the vehicular horn 3. The coverage areas α and β show the areas of the warning sound with its sound pressure measured as 50 dB or more. As described above, the supersonic speaker 5 of the present embodiment is disposed to emit a supersonic wave outward toward a frontal direction of the vehicle 100.

Further, the vehicular horn 3 is arranged to emit the warning sound substantially evenly around the vehicle, as shown in FIG. 4B. The horn opening 51 of the swirl shape horn 19 of the vehicular horn 3, from which the notification sound is emitted, is directed in a downward direction of the vehicle 100 to face the road surface. The direction of the horn opening 51 may also be set to another directions, and such directivity may be realized by using a reflector or the like.

(Control Circuit 8)

The vehicular horn 3 includes the control circuit 8, which includes a microcomputer chip 8a disposed on a control substrate as shown in FIG. 1, and disposed in the vehicular horn 3, as shown in FIG. 2A.

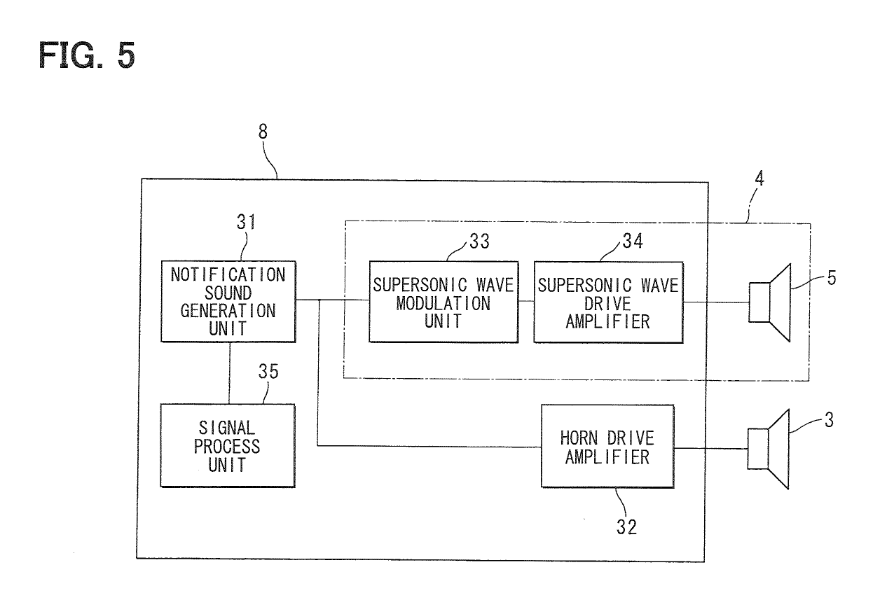

The control circuit 8 includes, as shown in FIG. 5:

(a) a notification sound generation unit 31 for generating a notification sound signal,

(b) a horn drive amplifier 32 for driving the vehicular horn 3 according to the notification sound signal,

(c) a supersonic wave modulation unit 33 for modulating the notification sound signal into a signal having the supersonic frequency,

(d) a supersonic wave drive amplifier 34 for driving the supersonic speaker 5 according to the supersonic modulated signal, and

(e) a signal process unit 35 for controlling the above-described operations.

In the following, the above-described elements of the control circuit 8 are explained.

(Notification Sound Generation Unit 31)

The notification sound generation unit 31 generates a pre-stored notification sound, such as a simulated engine sound, a single sound, a chord sound, a synthesized voice, and the like. The notification sound signal has an audible frequency according to the instruction from the signal process unit 35.

(Horn Drive Amplifier 32)

The horn drive amplifier 32 is a power amplifier that operates the vehicular horn 3 as a dynamic speaker. The horn drive amplifier 32 amplifies a notification sound signal from the notification sound generation unit 31, and outputs the amplified signal to the power terminals coupled to the coil 12 of the vehicular horn 3.

The maximum output of the horn drive amplifier 32 is restricted to 8 V or less, which is provided as the separate excitation voltage, and the voltage output from the horn drive amplifier 32 for generating the notification sound is configured to have a level that will not generate the warning sound from the vehicular horn 3. In other words, when the self-excitation voltage is equal to the separate excitation voltage (i.e. it is lower than 8V), the warning sound is not produced by the vehicular horn 3, but the notification sound is produced by the vehicular horn 3.

(Supersonic Wave Modulation Unit 33)

The supersonic wave modulation unit 33 performs a supersonic modulation to a notification sound signal from the notification sound generation unit 31.

In the present embodiment, the supersonic wave modulation unit 33 uses amplitude modulation (AM modulation) for modulating the notification sound signal into a signal of amplitude change (i.e., an increase and decrease change of the voltage) in the supersonic wave frequency (e.g., 25 kHz).

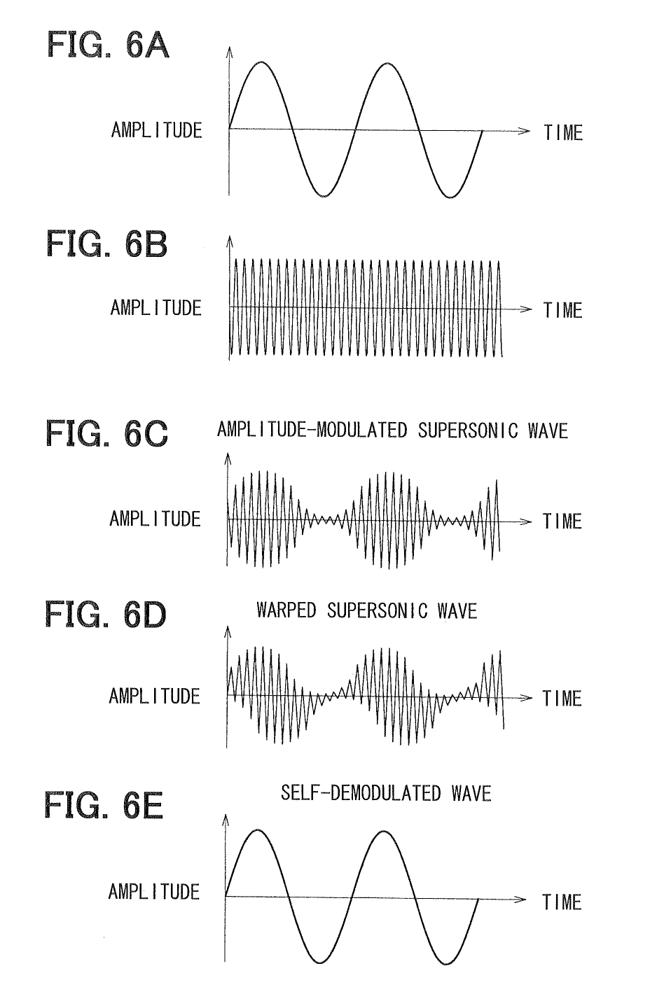

An example of the supersonic modulation by the supersonic wave modulation unit 33 is explained with reference to FIGS. 6A to 6C.

For example, a notification sound signal is provided to the supersonic wave modulation unit 33 as a voltage change having a wave form of a single frequency in FIG. 6A, which is showed for explanation purposes and should be understood that the wave form may take other forms.

A supersonic wave oscillator in the control circuit 8 oscillates at a supersonic frequency shown in FIG. 6B.

In FIG. 6C, the supersonic wave modulation unit 33 performs the following:

(i) as the signal voltage of the frequency to generate a notification sound signal increases, the supersonic wave modulation unit 33 increases the amplitude of the voltage of the supersonic wave vibration, and

(ii) as the signal voltage of the frequency to generate a notification sound signal decreases, the supersonic wave modulation unit 33 decreases the amplitude of the voltage by the supersonic wave vibration.

In the above-described manner, the supersonic wave modulation unit 33 modulates the notification sound signal output from the notification sound generation unit 31 into the amplitude change of the oscillation voltage having the supersonic wave frequency.

Further, the supersonic wave modulation unit 33 may use other modulation technique, such as pulse width modulation (PWM) that modulates a notification sound signal into a signal of width change (i.e., width of the pulse generation time) in the supersonic wave frequency.

(Supersonic Wave Drive Amplifier 34)

The supersonic wave drive amplifier 34 drives each of the piezoelectric speakers 22 based on the supersonic wave signal that is modulated by the supersonic wave modulation unit 33. That is, the supersonic wave drive amplifier 34 generates the supersonic wave, which is formed by the modulation of the notification sound signal, by controlling the applied voltage for (i.e., charging and discharging conditions of) each of the piezoelectric speakers 22.

In the present embodiment, the supersonic wave drive amplifier 34 may be a push-pull type analog amplifier (for example, a class B amplifier) that applies to each of the piezoelectric speakers 22 the increase and decrease of the voltage of the supersonic wave signal that is outputted from the supersonic wave modulation unit 33.

(Signal Process Unit 35)

The signal process unit 35 generates the notification sound when the signal process unit 35 receives a notification sound operation signal, which is an operation instruction signal, from, for example, an electronic control unit (ECU) of the vehicle 100.

The ECU may generate the notification sound operation signal in the following situations:

(i) The ECU generates the warning sound operation signal and provides the signal to the signal process unit 35 when the vehicle 100 is in a certain driving condition, which requires the output of the notification sound, such as when the vehicle 100 is traveling at a speed of 20 km/h or slower.

OR

(ii) The ECU generates the notification sound operation signal and provides the signal to the signal process unit 35 when the existence of a human being is confirmed by a human recognition system (not illustrated) in a traveling direction of the vehicle 100.

After receiving the notification sound operation signal from the ECU, the signal process unit 35 operates:

(i) the parametric speaker 4 to output a notification sound from the supersonic speaker 5, and

(ii) the vehicular horn 3 as a dynamic speaker to output the notification sound also from the vehicular horn 3.

(Operation of Vehicle Warning Apparatus)

When the notification sound operation signal is provided for the signal process unit 35 from the ECU, a supersonic wave, which is inaudible, is generated by modulating the notification sound signal. The supersonic wave (FIG. 6C) is emitted from the supersonic speaker 5 under the control of the signal process unit 35 toward a frontal direction of the vehicle 100.

In FIG. 6D, as the supersonic wave travels in the air, the supersonic wave having a short wave length is warped by, for example, a viscosity of the air or the like. That is, the edge of the supersonic wave dulls, due to the attenuation of the wave energy. As a result, as shown in FIG. 6E, an amplitude component in the supersonic wave is self-demodulated during the travel of the supersonic wave, thereby reproducing the notification sound. The notification sound produced by the supersonic wave is audible at a position that is distant from the vehicle 100.

Further, when the notification sound operation signal is provided for the signal process unit 35 from the ECU, a notification sound signal is amplified and is emitted from the vehicular horn 3 under control of the signal process unit 35. As a result, the notification sound is reproduced around the vehicle 100.

The vehicle warning apparatus in the present embodiment outputs, as described above, the notification sound from the parametric speaker 4 in a frontal direction outward from the vehicle 100, and from the vehicular horn 3, which functions as a dynamic speaker, for notifying the presence and approach of the vehicle 100.

### Advantageous Effects of the First Embodiment

### No. 1

The vehicle warning apparatus in the present embodiment positions the vehicular horn 3 between the supersonic speaker 5 and the heat exchanger 1, in a manner that when the vehicular warning apparatus is viewed from the front view, the supersonic speaker 5 is arranged to overlap the vehicular horn 3 and is away from the heat exchanger 1. More practically, the supersonic speaker 5 is arranged to be contained in an outline silhouette or contour of the vehicular horn 3 when viewed from the front view of the vehicle 100 towards the grille 2.

In such arrangement, heat from the heat exchanger 1 is prevented from directly contacting the supersonic speaker 5 by the vehicular horn 3. As a result, the supersonic speaker 5 it not heated by the heat from the heat exchanger 1, and a rise in temperature of the supersonic speaker 5 is prevented. Accordingly, a frequency change of the supersonic wave generated by the supersonic speaker 5 and the shortening of the product life due to such heat is also prevented.

### Advantageous Effects of the First Embodiment

### No. 2

The vehicular horn 3 and the supersonic speaker 5 in the present embodiment are arranged to overlap with each other in a front view of the vehicle 100 towards the grille 2. More practically, the supersonic speaker 5 is arranged to be contained in an outline silhouette of the vehicular horn 3.

In such arrangement, the installation of the supersonic speaker 5 does not affect the heat dissipation capacity (i.e., cooling capacity) of the heat exchanger 1, thereby enabling the heat dissipation capacity of the heat exchanger 1 to be maintained in a high level.

### Advantageous Effects of the First Embodiment

### No. 3

As provided above, the vehicle warning apparatus in the present embodiment has the supersonic speaker 5 disposed in the vehicular horn 3. In such manner, by only disposing the vehicular horn 3 in the vehicle 100, the supersonic speaker 5 is installed at the same time. In other words, install-ability of the supersonic speaker 5 is improved by saving a process for separately installing the supersonic speaker 5.

### Advantageous Effects of the First Embodiment

### No. 4

As provided earlier, the vehicle warning apparatus of the present embodiment arranges multiple piezoelectric speakers 22 on the same plane of the support board 23 in a collective arrangement. Therefore, the supersonic waves output from an array arrangement of those piezoelectric speakers 22 intensify with each other due to the synchronization of the wave phases, resulting in an extended outreach of the supersonic wave from the supersonic speaker 5.

Therefore, consumption of electric power by the supersonic wave drive amplifier 34 is reduced. Additionally, an increase of the production cost as well as an increase of volume of the supersonic speaker 5 is prevented by using only a small number of piezoelectric speakers 22 in the supersonic speaker 5.

### Second Embodiment

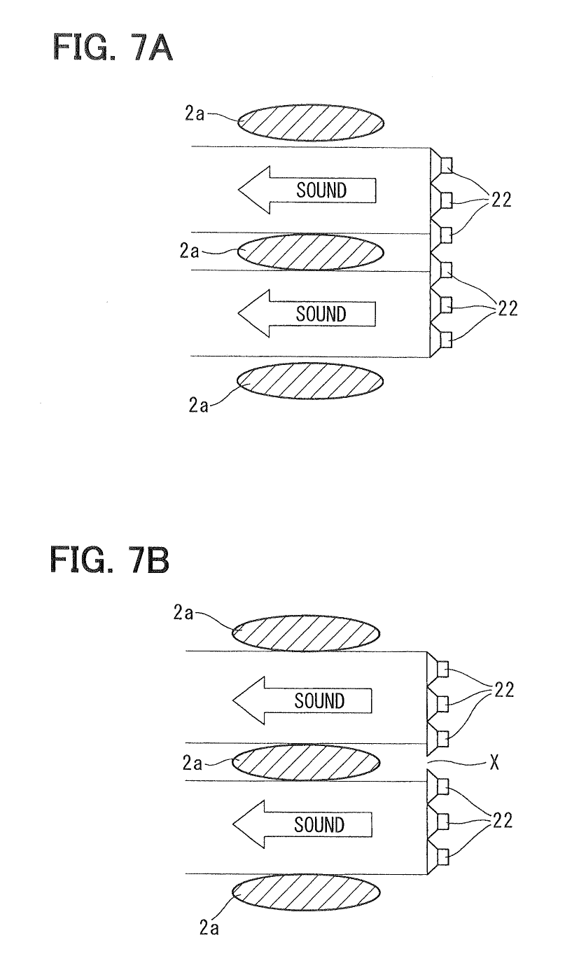

The second embodiment of the present disclosure is explained with reference to FIGS. 7A, 7B and 8.

Like parts have like numbers, in the second embodiment relative to the first embodiment.

The supersonic wave is known to have a characteristic of ease of reflection by an object. Further, as stated above, the supersonic speaker 5 is arranged behind the front grille 2. Therefore, when the vehicle 100 is viewed from the front towards the front grille 2, the supersonic wave output from the piezoelectric speaker 22, which is positioned right behind the grille member 2a as shown in FIG. 7A, is obstructed by the grille member 2a, thereby causing a decrease of the sound pressure of the supersonic wave.

The supersonic speaker 5 in the present embodiment is arranged in a manner in which all of the piezoelectric speakers 22 are not substantially obstructed by the grille member 2a. With reference to FIG. 8, when the vehicle 100 is viewed from the front towards the front grille 2, the piezoelectric speakers 22 are not hidden behind the grille member 2a and could be visible, where in FIG. 8 the piezoelectric speakers 22 are provided as a dotted line in the front view. In other words, the piezoelectric speakers 22 are positioned to substantial avoid overlapping with the grille member 2a.

More practically, the arrangement of the multiple piezoelectric speakers 22 forming a speaker array is devised to have a gap “X” (FIGS. 7B and 8), in a manner that accords with the shape of the grille member 2a (FIG. 7B), thereby enabling the multiple piezoelectric speakers 22 to be put at positions that overlap with the gap X in the front view of the vehicle 100.

In such manner, the reflection of the supersonic wave by the grille member 2a is prevented, as shown in FIG. 7B, thereby preventing a part of the supersonic wave from being wasted by such reflection. As a result, capacity deterioration of the supersonic speaker 5 by the front grille 2 is prevented.

Therefore, consumption of electric power by the supersonic wave drive amplifier 34 is reduced. Additionally, an increase of the production cost as well as an increase of volume of the supersonic speaker 5 is prevented by using only a small number of piezoelectric speakers 22 in the supersonic speaker 5.

In the above-mentioned embodiment, an example of the vehicular horn 3 has a swirl shape horn 19 (i.e., a trumpet member). However, the vehicular horn 3 may be implemented as a horn-less device that does not have the swirl shape horn 19 (e.g., a device that outputs the warning sound toward an outside of the vehicle 100 based on a vibration of the vibration board 14 and intensification of a sound by the resonance of a resonance board (i.e., resonance disk). Even in such case, the vehicular horn 3 is disposed between the supersonic speaker 5 and the heat exchanger 1.

In the above-mentioned embodiment, the vehicular horn 3 outputs the notification sound and the warning sound. However, the vehicular horn 3 may output the warning sound only. In other words, the notification sound may be outputted only from the parametric speaker 4. Further, the vehicle warning apparatus may be configured to generate the notification sound only by the vehicular horn 3.

Based on the foregoing, the vehicle warning apparatus notifies the presence and the approach of the vehicle 100 by way of a notification sound. Such vehicle warning apparatus is disposed in a vehicle that is equipped with the heat exchanger 1, the front grille 2, and the vehicular horn 3. The heat exchanger 1 may include a radiator, a condenser of an air-conditioner, or the like that are disposed in a front part of the vehicle in order to be cooled by air. The front grille 2 covers a front opening of the heat exchanger 1. The vehicular horn 3 is disposed between the heat exchanger 1 and the front grille 2, and outputs a warning sound upon having an operation of a horn switch by an occupant of the vehicle.

Such vehicle warning apparatus is realized by using a parametric speaker 4 that outputs a supersonic wave based on a supersonic modulation of a notification sound that radiates outward from the vehicle. The parametric speaker 4 includes the supersonic speaker 5 that outputs a supersonic wave toward an outside of the vehicle from a position between the heat exchanger 1 and the front grille 2.

From the front view of the vehicle, the vehicular horn 3 is disposed between the supersonic speaker 5 and the heat exchanger 1 in an overlapping manner. In other words, the vehicular horn 3 and the supersonic speaker 5 overlap with each other.

In such manner, heat from the heat exchanger 1 is prevented from directly hitting the supersonic speaker 5. Therefore, the temperature of supersonic speaker 5 is controlled and does not increase because of the heat exchanger 1, and the supersonic speaker 5 does not deteriorate.

Although the present disclosure has been fully described in connection with preferred embodiment thereof with reference to the accompanying drawings, it is to be noted that various changes and modifications will become apparent to those skilled in the art, and changes, modifications, and summarized schemes are to be understood as being within the scope of the present disclosure as defined by appended claims.

What is claimed is:

1. A vehicle warning apparatus in a vehicle that is equipped with a a heat exchanger that is positioned at a front position of the vehicle to be cooled by a travel-caused wind, and a vehicular horn that generates a warning sound when a horn switch is operated by a vehicle occupant, the vehicle warning apparatus comprising:
a parametric speaker that outputs a supersonic wave outward from the vehicle, the parametric speaker is equipped with a supersonic speaker,
wherein, the supersonic speaker and the vehicular horn are arranged in an overlapping manner, such that the vehicular horn is disposed between the heat exchanger and the supersonic speaker.

2. The vehicle warning apparatus of claim 1, wherein
the vehicular horn is equipped with a swirl shape horn that intensifies the warning sound, the swirl shape horn has a curved body that defines an opening at one end from which the warning sound is emitted; and
the supersonic speaker is arranged on an outer surface of the swirl shape horn, such that the supersonic speaker is positioned next to the swirl shape horn and in front of the vehicular horn.

3. The vehicle warning apparatus of claim 1, wherein
the supersonic speaker includes a support board and a plurality of speakers, the support board is configured to have a flat planar shape on which the speakers are arranged.

4. The vehicle warning apparatus of claim 1, wherein
the supersonic speaker is arranged on an outer contour of the vehicular horn.
